(19) United States
(12) Patent Application Publication
(10) Pub. No.: US 2014/0002857 A1
(43) Pub. Date: Jan. 2, 2014

(54) DOCUMENT SCANNING METHOD AND COMPUTER PROGRAM FOR CONTROLLING SCANNING APPARATUS

(71) Applicant: AVISION INC., Hsinchu (TW)

(72) Inventors: Chun Ping HUANG, Yanpu Township (TW); Hung-Jen LIN, Yanpu Township (TW)

(21) Appl. No.: 13/928,025

(22) Filed: Jun. 26, 2013

(30) Foreign Application Priority Data
Jun. 28, 2012 (TW) 101123134

(51) Int. Cl. H04N 1/00

(52) U.S. Cl. CPC H04N 1/00222; H04N 1/00278
USPC 358/1.15

(57) ABSTRACT

A document scanning method for use in a scanning apparatus is provided. The method includes steps of: connecting to a mobile device via a network; receiving a scan execution request from the mobile device; scanning a document and generating corresponding scan image data according to the scan execution request; and automatically transmitting the scan image data to a destination according to the scan execution request after completing scanning the document. A computer program for controlling the scanning apparatus is also provided.

### CROSS REFERENCE TO RELATED APPLICATIONS

This application claims the benefit of the foreign application priority of Taiwan Application No. 101123134, which was filed on Jun. 28, 2012 and is incorporated herein by reference.

### BACKGROUND OF THE INVENTION

1. Field of the Invention

The present invention relates generally to a document scanning method and a computer program, and especially relates to the document scanning method of a scanning apparatus and the computer program for configuring a mobile device, such as mobile phone, PDA (Personal Digital Assistant), tablet, and etc., to control a scanning apparatus to execute the document scan operation.

2. Description of the Prior Art

A conventional scanner is connected to a computer through a cable line, and the user controls the scanner by using the scanner application installed on the computer or entering commands though the control panel mounted on the scanner casing. After the scan job is done, the scanner transmits the scan image data to the connected computer. On the computer, the user may choose to store the scan image data as a file or to send it to a server over a network.

The network scanner is another type of scanner, which is configured to directly connect to a network. Since such a scanner does not connect to a computer, the user operates at the device end and the scan image data is directly sent to a server. However, to retrieve the scan image data from the server, the user must go to a computer terminal to run a data retrieval procedure.

Even though nowadays mobile devices are commonly seen and owned, they mostly are used as a mass storage device to a scanner, or used for retrieving the scan image data from the 3G server.

The present invention provides a method and a computer program for operating a scanning apparatus wirelessly, to simplify the document scanning operation and the data transmission process.

### SUMMARY OF THE INVENTION

Accordingly, an object of the present invention is to provide a document scanning method and a computer program which allow users to operate a scanning apparatus and input instructions through a user interface of a mobile device and facilitate transmission of data to a user-designated location immediately after the completion of the scan job.

In one embodiment, the present invention relates to a document scanning method for use in a scanning apparatus. The method comprises the following steps: connecting to a mobile device via a network; receiving a scan execution request from the mobile device; scanning a document and generating corresponding scan image data according to the scan execution request; and automatically transmitting the scan image data to a destination according to the scan execution request after completing scanning the document.

Further, in another embodiment, the present invention relates to a computer program having computer readable instructions which, when loaded onto a mobile device, configure the mobile device to perform a method of controlling a scanning apparatus. The method comprises the following steps: enabling connection to a scanning apparatus via a network; and transmitting a scan execution request to the scanning apparatus.

The method and computer program of the present invention facilitate a mobile device directly controlling a scanner and promptly receiving scan image data, and further have the following advantages:

1. Having the computer program of the present invention installed thereon, the mobile device can control a scanner and receive the scan image data without the installation of a third party application, e.g. cloud service application, such as Dropbox or Evernote, and/or using a computer to retrieve the scan image data.

2. The mobile device can control a scanner to scan a document and obtain scan image data without connecting to the scanner with a cable or adapting a complicate user interface.

3. The user may customize the scan functions and settings on the mobile device in accordance with the user's needs and preferences and apply the same settings on all the scanners even when a different scanner is connected to the mobile device each time.

4. Since the scanner is directly controlled by the mobile device, the scanner need not carry a control panel. Hence, fewer components are used in the scanner and the scanner consumes less power.

These and other objects, features and advantages of the present invention will become apparent upon consideration of the following detailed description of the preferred embodiment that is illustrated in the various figures and drawings.

### BRIEF DESCRIPTION OF THE DRAWINGS

FIG. 1 shows a configuration of a network system for use in the embodiments of the present invention.

FIG. 2 shows a block diagram of the multifunction printer executing a document scanning method according to a first embodiment of the present invention.

FIG. 3 shows a block diagram of the peripheral scanner connected to the computer of the LAN, which executes a document scanning method according to a second embodiment of the present invention.

FIG. 4 shows a block diagram of the mobile phone used in the first and second embodiments of the present invention.

FIG. 5 is an example of a user interface of the mobile phone of FIG. 4 presenting a plurality of selectable scanning apparatuses.

FIG. 6 and FIG. 7 are two examples of a user interface of the mobile phone of FIG. 4 presenting a plurality of selectable functions of the scanning apparatus connected to the mobile phone.

FIG. 8 is a flow chart of the document scanning method according to the first embodiment of the present invention.

FIG. 9 is a flow chart of the document scanning method according to the second embodiment of the present invention.

FIG. 10 is a flow chart of a method of controlling a scanning apparatus performed by a computer program loaded in the mobile phone according to the present invention.

### DETAILED DESCRIPTION

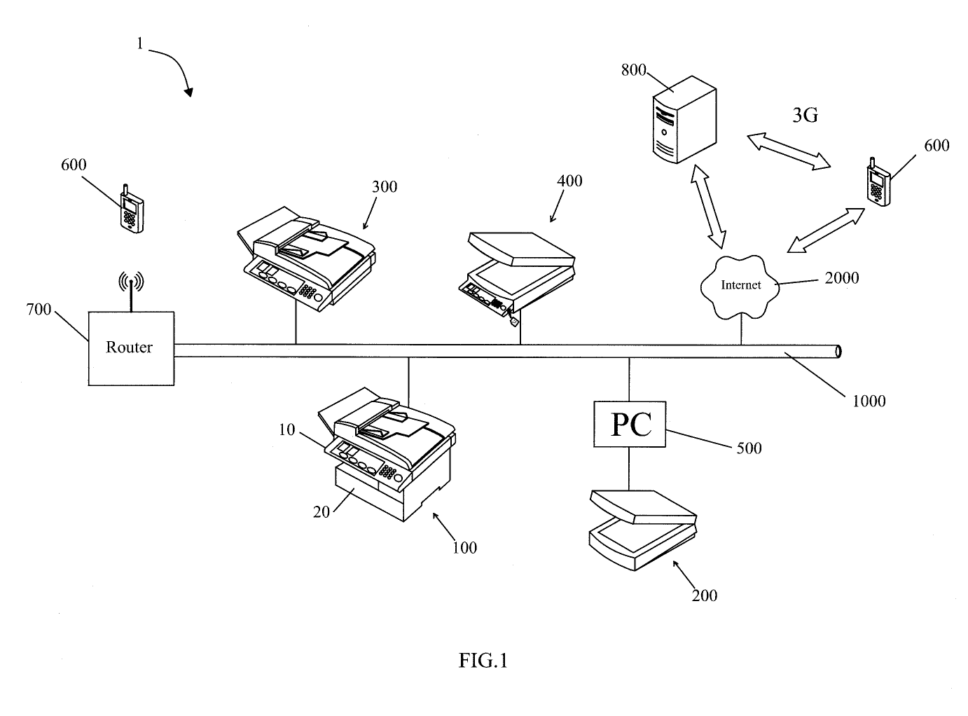

FIG. 1 shows a configuration of a network system 1 for use in the embodiments of the present invention. As show in FIG. 1, a multifunction printer (MFP) 100, an automatic document feeding scanner (ADF scanner) 300, a flatbed scanner 400 and a computer 500 are interconnected via a local area network (LAN) 1000, such as an Ethernet LAN. The LAN 1000 is linked to an internet 2000; therefore, the MFP 100, ADF scanner 300, flatbed scanner 400 and the computer 500 may communicate with other digital apparatuses using the internet 2000. The computer 500 is a personal computer, and a peripheral scanner 200 is connected to the computer 300 as a peripheral device.

A router 700 with a built-in access point (AP) is connected to the LAN 1000 and serves a bridge for the wireless and cable network. Once mobile devices, such as mobile phones, tablet computers, or laptops, are connected to the AP, they can communicate with the MFP 100, ADF scanner 300, flatbed scanner 400 and the computer 500 of the LAN 1000. In the embodiments of the present invention, the mobile phone 600 can connected to the internet 2000 through mobile services provided by the telecommunication providers or by turning on the Wi-Fi functionality to connect to the LAN 1000.

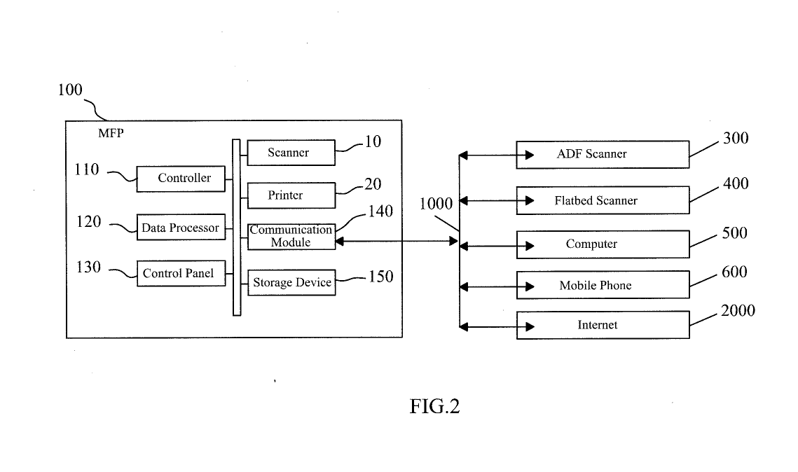

FIG. 2 shows a block diagram of the multifunction printer 100 executing a document scanning method according to a first embodiment of the present invention. In this embodiment, the MFP 100 is the scanning apparatus of the present invention and will be used to explain the implementation of the document scanning method on a scanning apparatus which is directly connected to a network. The mobile phone 600 is operable to send commands to the MFP 100 to start a document san operation. The mobile phone 600 can also control the ADF scanner 300 and the flatbed scanner 400, if connected. As shown in FIG. 2, the MFP 100 comprises a scanner 10, a printer 20, a controller 110, a data processor 120, a control panel 130, a communication module 140 and a storage device 150. The scanner 10 is operable to scan a document and generates scan image data correspondingly. The printer 20 prints out data. The MFP 100, besides carrying out the scan, copy and printing jobs, can send the scan image data to a server for electronic filing and perform post-processing on the scan image data for emails and fax. The controller 110 controls and manages the operations of the MFP 100. The data processor 120 processes the data generated as a result of a scan job into output data. For example, the data processor 120 performs image-cropping or tilt-correction processing on the scan image data, and converts the scan image data into formats of print data or email attachments. The control panel 130 includes devices such as displays and buttons, to deliver messages to users and to receive user input. The communication module 140 communicates with the LAN 1000 for exchanging data and signals with the ADF scanner 300, flatbed scanner 400, computer 500 and the mobile phone 600 over the LAN 1000. The communication module 140 includes network interface cards and communication programs installed in the MFP 100. The storage device 150 could be any of the built-in hard drive, memory, or removable memory card or USB drive, for storing data and files.

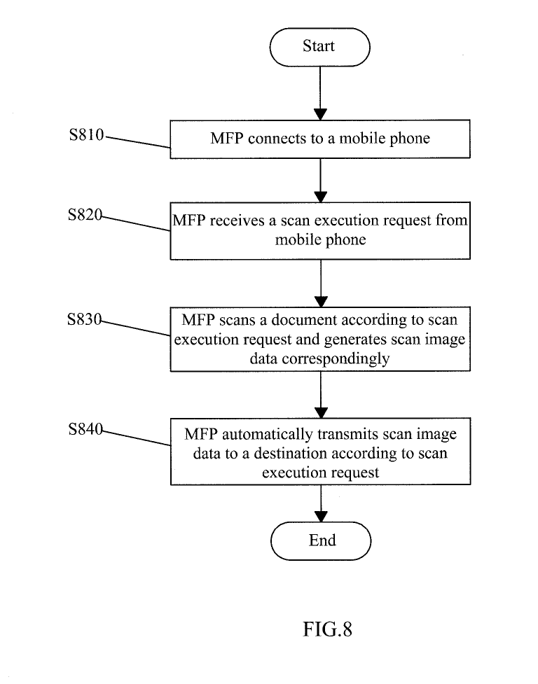

FIG. 8 is a flow chart of the document scanning method according to the first embodiment of the present invention. Referring to FIG. 1, FIG. 2 and FIG. 8, the document scanning method comprises steps as follows.

Step S810: The MFP 1000 connects to the mobile phone 600. The mobile phone 600 is connected to the LAN 1000 through Wi-Fi or 3G/4G networks. A computer program, such as an application program APP, is installed in the mobile phone 600, by which the mobile phone 600 is able to communicate with the MFP 100 or any other scanning apparatus like the ADF scanner 300, flatbed scanners 200 and 400.

Step S820: The MFP 100 receives a scan execution request from the mobile phone 600.

Step S830: The MFP 100 scans a document according to the scan execution request and generates scan image data correspondingly.

Step S840: The MFP 100 automatically transmits the scan image data to a destination according to the scan execution request after completing scanning the document. The user may select the destination on the mobile phone 600 through the user interface (UI) provided, or the MFP 100 may correspondingly display a number of options showing output destinations for user to select from, after receiving the scan execution request. The destinations may include the storage device 150, printer 20, mobile phone 600 or any server (including cloud server), terminal or mobile devices connected to the LAN 1000.

If the mobile phone 600 is connected to the LAN 1000 via the 3G network, the MFP 1000 can transmit the scan image data to a server 800 (of a telecommunication provider) connected to the LAN 1000 and the server 800 transmits the scan image data to the mobile phone 600. The server 800 may transmit the scan image data to the mobile phone 600 through PUSH service. The MFP 100 may either transmit the scan image data directly to the mobile phone 600 over Wi-Fi network, or send the scan image data to the server 800, dependent on the connection, or concurrently. The user would immediately receive the scan image data after the MPF 100 completes the scan job, without retrieving the scan image data manually.

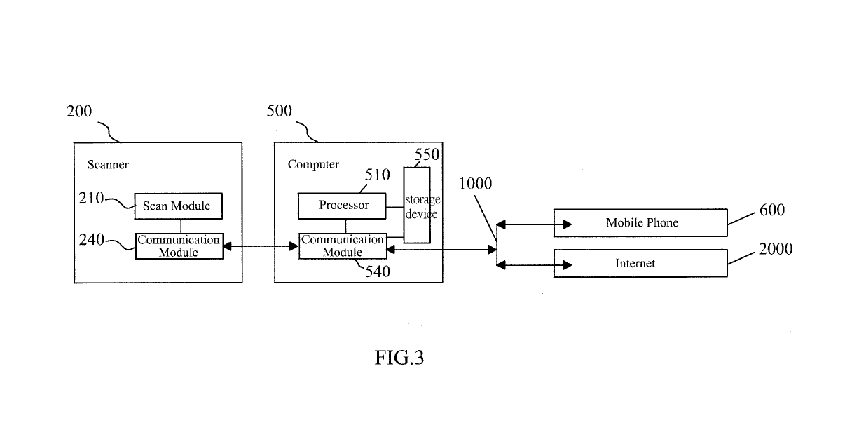

FIG. 3 shows a block diagram of the peripheral scanner 200 connected to the computer 500 of the LAN 1000, which executes a document scanning method according to a second embodiment of the present invention. Referring to FIG. 3, the peripheral scanner 200 comprises a scan module 210 and a communication module 240. The scan module 210 is operable to read the image of a document. Through the connection between the communication module 240 and the computer 500, the peripheral scanner 200 transmits scan image data, generated as a result of a scan job, to the computer 500 for post processing and data storage. In this embodiment, the peripheral scanner 200 is a computer peripheral which is driven and controlled by the computer 500 and is without network connection. Any data from the peripheral scanner 200 to the mobile phone 600 and internet 2000 will be translated and transferred by the computer 500. The computer 500 comprises a processor 510, a communication module 540 and a storage device 550.

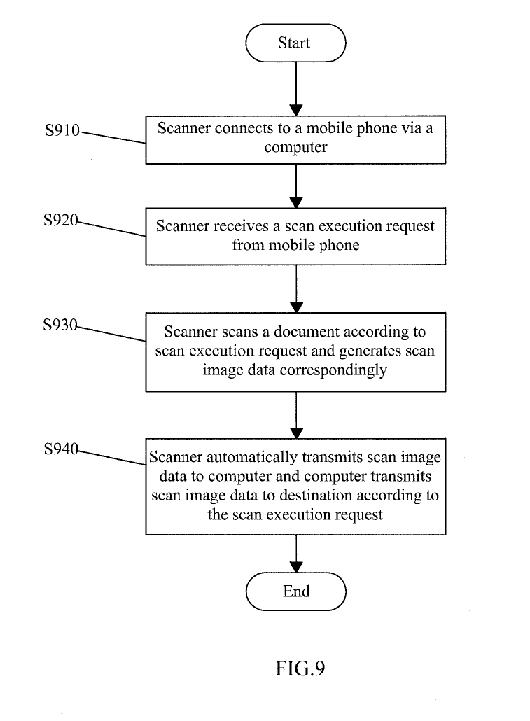

FIG. 9 is a flow chart of the document scanning method according to the second embodiment of the present invention. Referring to FIG. 1, FIG. 3 and FIG. 8, the document scanning method comprises steps as follows.

Step S910: The peripheral scanner 200 connects to the mobile phone 600. Because the peripheral scanner 200 is connected to the LAN 1000 through the computer 500, the connection between the peripheral scanner 200 and the mobile phone 600 is also through the computer 500.

Step S920: The peripheral scanner 200 receives a scan execution request from the mobile phone 600. In detail, the mobile phone 600 sends out the scan execution request to the computer 500, and then the computer 500 in response transmits a scan execution signal to the peripheral scanner 200 according to the scan execution request to instruct the peripheral scanner 200 to execute a scan job.

Step S930: The peripheral scanner 200 scans a document according to the scan execution signal and generates scan image data correspondingly.

Step S940: The peripheral scanner 200 automatically transmits the scan image data to a destination according to the scan execution request after completing scanning the document. If the destination is the mobile phone 600 or any other device connected to the computer 500 through the LAN 1000, the peripheral scanner 200 first sends the scan image data to the computer 500 and then the computer 500 transmits the scan image data to the destination. If the peripheral scanner 200 does not have any ASIC or processor for image processing, after receiving the original scan image data from the peripheral scanner 200, the computer 500 performs image processing on the scan image data, for example image compression, conversion, OCR and etc., and then send the processed scan image data to the destination.

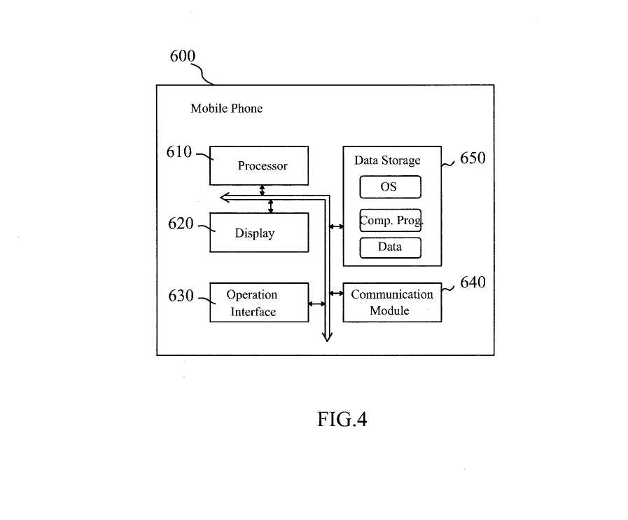

FIG. 4 shows a block diagram of the mobile phone 600 used in the first and second embodiments of the present invention. As shown in FIG. 4, the mobile phone 600 comprises a processor 610, a display 620, an operation interface 630, a communication module 640 and a data storage 650. The processor 610 carries out the instructions of the computer programs stored in the data storage 650 and manages the operations of the mobile phone 600. The operation interface 630, for example, the keypad and buttons, is provided for users to input instructions and commands. The display 620 can be a touch screen which incorporates the functions of the operation interface 630. The data storage 650 includes the internal memory of the mobile phone 600 and its expanded memory.

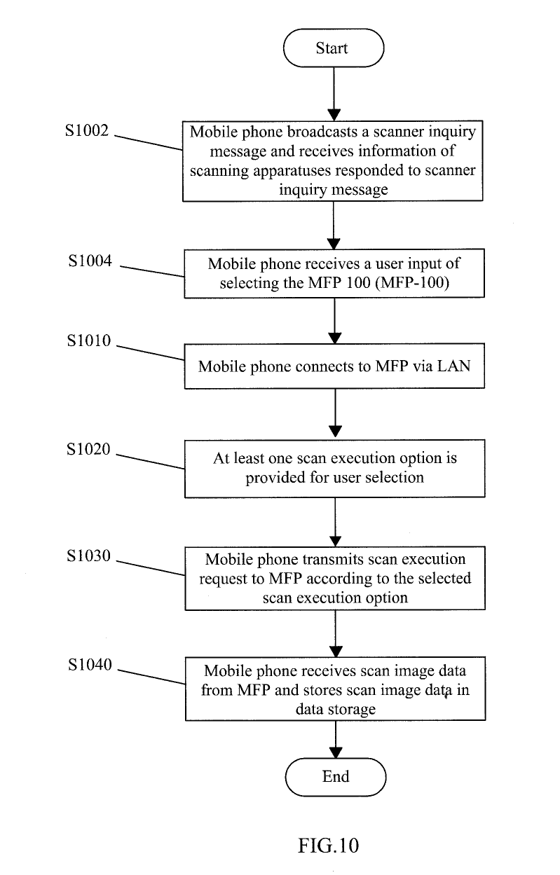

In order for the mobile phone 600 to communicate with the MFP 600, ADF scanner 300, flatbed scanner 400 and the computer 500, besides the communication modules (including the network communication program) are required to be installed in these MFP 600, ADF scanner 300, flatbed scanner 400 and computer 500, the mobile phone 600 itself must be loaded with an application program APP to execute a method of controlling a scanning apparatus. FIG. 10 is a flow chart of the method of controlling the scanning apparatus performed by the computer program loaded in the mobile phone according to the present invention. The method comprises steps as follows.

Step S1002: The mobile phone 600 broadcasts a scanner inquiry message and receives information of the scanning apparatuses responded to the scanner inquiry message. This step S1002 can be omitted. Alternatively, the user can select one of the scanning apparatus already programmed or registered in the mobile phone 600 and the mobile phone 600 would connect to the selected scanning apparatus if the scanning apparatus is online. FIG. 5 is an example of a user interface 622 of the mobile phone 600 of FIG. 4 presenting a plurality of selectable scanning apparatuses. Through the user interface 622 the user can examine the available scanning apparatus and input his selection.

Step S1004: The mobile phone 600 receives a user input of selecting the scanning apparatus, for example, the MFP 100 (Code Name MFP-100), as shown in FIG. 5.

Step S1010: The mobile phone 600 connects to the MFP 100 over the LAN 1000 (and internet 2000, if applicable).

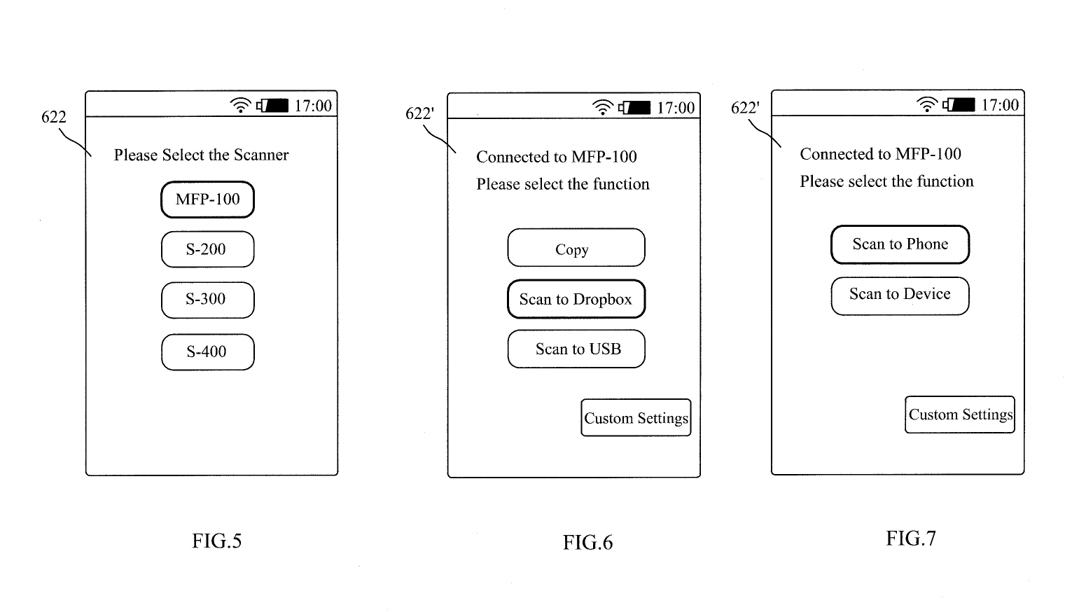

Step S1020: At least one scan execution option is provided for user selection. FIG. 6 and FIG. 7 are two examples of a user interface 622′ of the mobile phone of FIG. 4 presenting a plurality of selectable functions of the scanning apparatus connected to the mobile phone. As shown in FIG. 6, the user interface 622′ displays the scan execution options—“Copy”, “Scan to Dropbox”, and “Scan to USB”. These scan execution options, including their size and quantities, are customizable by the user. As shown in FIG. 7, the user can customized the functions and choose to show only the scan execution options—“Scan to Phone” and “Scan to Device”.

Step S1030: The mobile phone 600 transmits the scan execution request to the MFP 100 according to the selected scan execution option. If the user selects the scan execution option “Scan to Phone”, in response the mobile phone 600 transmits the scan execution request to the MFP 100 giving instruction that the scan image data is to be sent to the mobile phone 600.

Step S1040: The mobile phone 600 receives scan image data from the MFP 100 and stores the scan image data in the data storage 650. The scan image data is generated by the MFP 100 according to the scan execution request. Upon receiving the scan execution request from the mobile phone 600, the MFP 100 scans a document according to the scan execution request and generates the scan image data correspondingly, and transmits the scan image data to the mobile phone 600. When the mobile 600 receives the scan image data, it stores the scan image data in the data storage 650. If the mobile phone 600 is connected to the LAN 1000 through the 3G network, the mobile phone 600 receives the scan image data from the server 800.

While the present invention has been described with respect to a limited number of embodiments, it is to be understood that the present invention is not limited to the disclosed exemplary embodiments. It is intended that the appended claims cover all modifications, equivalent structures and variations as fall within the true spirit and scope of this present invention. The specification and drawings are, accordingly, to be regarded in an illustrative rather than a restrictive sense.

What is claimed is:

1. A document scanning method for use in a scanning apparatus, comprising steps of:
connecting to a mobile device via a network;
receiving a scan execution request from the mobile device;
scanning a document according to the scan execution request and generating scan image data correspondingly; and
automatically transmitting the scan image data to a destination according to the scan execution request after completing scanning the document.

2. The method of claim 1, wherein the step of automatically transmitting the scan image data to the destination comprises:
transmitting the scan image data to the destination via a computer which is connected to the scanning apparatus.

3. The method of claim 2, wherein the scan image data transmitted to the destination is processed by the computer.

4. The method of claim 1, wherein the step of automatically transmitting the scan image data to the destination comprises:
transmitting the scan image data to the destination via a server on the network, wherein the destination is the mobile device or a second mobile device.

5. The method of claim 1, wherein the destination is a storage device and the scan image data is transmitted to and stored in the storage device.

6. The method of claim 1, wherein the destination is a printer and the printer prints out the scan image data.

7. The method of claim 1, further comprising:
providing according to the scan execution request a plurality of destination options for users to select.

8. A computer program having computer readable instructions which, when loaded onto a mobile device, configure the mobile device to perform a method of controlling a scanning apparatus, wherein the method comprises steps of:
enabling connection to a scanning apparatus via a network; and
transmitting a scan execution request to the scanning apparatus.

9. The computer program of claim 8, wherein the method further comprises the step of:
receiving scan image data and storing the scan image data in a data storage of the mobile device, wherein the scan image data is generated by the scanning apparatus according to the scan execution request.

10. The computer program of claim 9, wherein the step of receiving the scan image data comprises:
receiving the scan image data from a server on the network.

11. The computer program of claim 8, wherein before the step of enabling connection to the scanning apparatus via the network, the method further comprises steps of:
broadcasting a scanner inquiry message and receiving information of the scanning apparatus responded to the scanner inquiry message; and
receiving a user input of selecting the scanning apparatus.

12. The computer program of claim 8, wherein the step of transmitting the scan execution request to the scanning apparatus comprises:
providing at least one scan execution option for a user to select; and
transmitting the scan execution request to the scanning apparatus according to the selected scan execution option;
wherein the at least one scan execution option is customizable by the user.
